(19) United States
(12) Patent Application Publication
(10) Pub. No.: US 2007/0181027 A1
(43) Pub. Date: Aug. 9, 2007

(54) MISREGISTRATION JUDGING METHOD, REGISTRATION MARK FOR COLOR PRINTING, COLOR SLIPPAGE DETECTION MARK, COLOR SLIPPAGE CORRECTION CHART, COLOR REGISTRATION CORRECTION CHART COLOR SLIPPAGE DETECTION METHOD COLOR SLIPPAGE CORRECTION

(75) Inventor: Keizen Kanazawa, Osaka (JP)

Correspondence Address: BELL, BOYD & LLOYD, LLP, P.O. Box 1135, CHICAGO, IL, 60690, US

(73) Assignee: KYOCERA MITA CORPORATION, Osaka (JP)

(21) Appl. No.: 11/548,193

(22) Filed: Oct. 10, 2006

(30) Foreign Application Priority Data
Oct. 14, 2005 (JP) 2005-300657
Feb. 13, 2006 (JP) 2006-035476
Feb. 13, 2006 (JP) 2006-035477

(51) Int. Cl. B41F 33/00

(52) U.S. Cl. 101/484

(57) ABSTRACT

A misregistration judging method, registration mark for color printing, color slippage detection mark, color slippage correction chart, color registration correction chart, color slippage detection method color slippage correction method, and color image forming apparatus are provided. The color image forming apparatus prints registration marks for color printing respectively including marks of reference colors and marks of colors for measurement that are centered at same positions and having similar figures and judges any relative positional displacement, if any, of a mark of a reference color and the corresponding mark of the color for measurement as misregistration.

### CROSS REFERENCES TO RELATED APPLICATION

This application claims priority to Japanese Patent Application No. 2005-300657 filed on Oct. 14, 2005 and Japanese Patent Applications Nos. 2006-035476 and 2006-035477, filed on Feb. 13, 2006, the entire contents of which are incorporated herein by reference in their entirety.

### BACKGROUND

This application relates to a misregistration judging method for judging a color slippage in color printing, a registration mark for color printing, a color slippage detection mark, a color slippage correction chart, a color registration correction chart, a color slippage detection method, a color slippage correction method and a color image forming apparatus.

Conventionally, color printed matters have been and are prepared by printing in four colors of Y (yellow), M (magenta), C (cyan) and BL (black). The operation of properly positioning the four colors of Y, M, C and BL for producing a color printed matter is referred to as registration. In color printing, so-called misregistration occurs when the four colors of Y, M, C and BL are not placed at their respective correct positions on a sheet. If misregistration takes place, it is not possible to produce a good printed product.

Known printing registration marks for color printings include cross-shaped registration marks and concentrically circular registration marks. However, it is difficult with any of them to accurately judge how misregistration is taking place because registration marks of different colors are laid one on the other. Then, it is difficult to accurately determine which color is misregistered in which direction to what extent if color registration marks are printed substantially at right positions.

Additionally, since known color registration marks are designed mainly to find out the extent and the direction of misregistration visually or by means of a magnifier and hence not adapted to detect the extent and the direction of misregistration if they are very small.

There have also been proposed techniques of laying circles concentrically to automatically detect color slippages. With any of these techniques, a mackle detection mark is formed by using a central mark, which is a small circle, and a ring-shaped mark that concentrically surrounds the central mark and if the printed mackle detection mark shows a difference between the long axis and the short axis thereof when they are measured, the difference between the two axes and the direction of the long axis that passes through the central mark are defined respectively to be the extent and the direction of mackle (see, inter alia, Jpn. Pat. Appln. Laid-Open Publication No. 2002-192701).

There have also been proposed registration marks for printing including a group of registration mark elements having different respective profiles so as to correspond to different colors. With any of these registration marks for printing, the extent of misregistration of each color is detected by referring to the position of the registration mark element of the color that operates as reference (see, inter alia, Jpn. Pat. Appln. Laid-Open Publication No. 2002-192702).

However, with the above-cited known techniques of detecting a color slippage by concentrically laying two circles one on the other, it is difficult to visually judge any color slippage.

Registration marks for printing including a group of registration mark elements having different respective profiles so as to correspond to different colors, by means of which the extent of misregistration of each color is detected by referring to the position of registration mark element of the color that operates as reference, are not suitable for visual observations because the registration mark is very small and the color slippage of the registration mark is to be observed by means of an instrument. Additionally, such a registration mark is accompanied by a drawback that an observer can see it with difficulty because all the four colors are printed around a single reference color.

### SUMMARY

In view of the above identified circumstances, it is therefore desirable to provide a misregistration judging method with which an observer can visually and easily judge a color slippage in color printing as well as a registration mark for color printing, a color slippage detection mark, a color slippage correction chart, a color registration correction chart, a color slippage detection method, a color slippage correction method and a color image forming apparatus.

Further, it is desirable to make it possible to highly accurately detect color slippages in color printing.

Still further it is desirable to make it possible to highly accurately detect and correct color slippages in color printing.

In an embodiment, a misregistration judging method is provided. The method includes printing a registration mark for color printing including a mark of a reference color and a mark of a color for measurement, the marks being centered at a same position and having similar figures, on a sheet of paper; and judging the relative positional displacement, if any, of the mark of the reference color and the mark of the color for measurement printed on the sheet of paper as misregistration.

In another embodiment, there is also provided a registration mark for color printing including: a mark of a reference color; and a mark of a color for measurement which is centered at a same position as the mark of a reference color, and has a figure which is similar to that of the mark of a reference color.

Preferably, in a registration mark for color printing as defined above, the mark of the reference color and the mark of the color for measurement may be concentric circles.

Preferably, in a registration mark for color printing as defined above, the mark of the reference color and the mark of the color for measurement may be crosses.

Preferably, in a registration mark for color printing as defined above, the larger one of the mark of the reference color and the mark of the color for measurement may have a figure formed by cutting out the figure of the smaller one.

In still another embodiment, there is provided a color registration correction chart including: a registration mark for color printing which is printed on a sheet of paper, the registration mark for color printing including a mark of a reference color, and a mark of a color for measurement which is centered at a same position as the mark of a reference color, and has a figure which is similar to that of the mark of a reference color.

Preferably, in a color registration correction chart as defined above, registration marks for color printing are printed at symmetrical positions to form one or more than one pairs on a sheet of paper.

In still another embodiment, there is provided a color image forming apparatus including: storage means for storing printing data of a registration mark for color printing, the registration mark for color printing including a mark of a reference color, and a mark of a color for measurement which is centered at a same position as the mark of a reference color, and has a figure which is similar to that of the mark of a reference color; and control means for controlling the operation of reading the printing data of the registration mark for color printing from the storage means and printing it on a sheet of paper according to an instruction.

Preferably, in a color image forming apparatus as defined above, the storage means may store printing data for printing registration marks for color printing at symmetrical positions to form one or more than one pairs on a sheet of paper.

Thus, it is now possible to visually and accurately judge with ease any color slippage in color printing by means of a registration mark for color printing according to the present invention.

In still another embodiment, there is provided a color slippage detection mark including: dots of printing colors alternately arranged as repetition of a unit of a predetermined number of dots.

Preferably, in a color slippage detection mark as defined above, the unit of repetition of dots of printing colors is the smallest unit of dots.

In still another embodiment, there is provided a color slippage detection method including the steps of: preliminarily measuring color attributes of a color slippage detection mark including dots of printing colors alternately arranged as repetition of a unit of a predetermined number of dots; storing the measured color attributes; and detecting a color slippage, if any, by printing the color slippage detection mark on a sheet of paper, measuring color attributes and comparing them with the stored color attributes.

In still another embodiment, there is provided a color image forming apparatus including: a storage means for storing printing data of a color slippage detection mark including dots of printing colors alternately arranged as repetition of a unit of a predetermined number of dots; and a control means for controlling the operation of reading the printing data of the color slippage detection mark from the storage means and printing it on a sheet of paper according to an instruction.

Thus, it is now possible to highly accurately detect any color slippage in color printing by means of a color slippage detection mark according to the present invention.

In still another embodiment, there is provided a color slippage correction chart including: color slippage detection marks of several different types formed by means of dots of printing colors alternately arranged as repetition of a unit of a predetermined number of dots and shifting the printing colors in a direction by the smallest unit of correction.

In still another embodiment, there is provided a color slippage correction method including the steps of: printing color slippage correction charts of printing colors on a sheet of paper, each including color slippage detection marks of several different types formed by means of dots of printing colors alternately arranged as repetition of a unit of a predetermined number of dots and shifting the printing colors in a direction by the smallest unit of correction; and measuring color attributes for the color slippage detection mark of each printing color of the color slippage correction chart printed on the sheet of paper, selecting a color slippage detection mark having color attributes close to those of the related target color and correcting the color slippage of the printing color according to the color slippage detection mark.

In still another aspect embodiment, there is provided a color image forming apparatus including: a storage means for storing printing data on color slippage correction charts of printing colors, each including color slippage detection marks of several different types formed by means of dots of printing colors alternately arranged as repetition of a unit of a predetermined number of dots and shifting the printing colors in a direction by the smallest unit of correction; and a control means for controlling the operation of reading out the printing data on the color slippage correction chart from the storage means and printing them on a sheet of paper according to an instruction.

Thus, it is now possible to highly accurately detect and correct any color slippage in color printing by means of color slippage correction charts according to the present invention.

Additional features and advantages are described herein, and will be apparent from, the following Detailed Description and the figures.

### BRIEF DESCRIPTION OF THE FIGURES

FIG. 1 is a schematic block diagram of an embodiment of image forming apparatus illustrative of the present application.

FIG. 2 is a flowchart of the operation of the image forming apparatus of FIG. 1.

FIGS. 3A, 3B and 3C are schematic illustrations of registration marks for color printing, each including a mark of a reference color and a mark of a color for measurement showing figures of crosses.

FIGS. 4A, 4B and 4C are schematic illustrations of registration marks for color printing, each including a mark of a reference color and a mark of a color for measurement showing figures of concentric circles.

FIG. 5 is a schematic illustration of the printed first registration mark for color printing when the color of cyan is displaced lower right with the image forming apparatus of FIG. 1.

FIG. 6 is a schematic illustration of the printed fourth registration mark for color printing when the color of cyan is displaced lower right with the image forming apparatus of FIG. 1.

FIG. 7 is a schematic illustration of the printed first registration mark for color printing when no space is provided between the mark of a reference color and the mark of a color for measurement showing figures of crosses by the nature of emulation and the color of cyan is displaced lower right with the image forming apparatus of FIG. 1.

FIG. 8 is a schematic illustration of a larger mark having a figure formed by cutting out the figure of a smaller mark.

FIG. 9 is a schematic illustration of a color registration correction chart prepared by the image forming apparatus of FIG. 1.

FIG. 10 is a schematic block diagram of a color image forming apparatus according to the present invention and provided with a functional feature of preparing color registration correction charts.

FIG. 11 is a schematic illustration of a color slippage detection mark printed by the image forming apparatus of FIG. 10 without any color slippage.

FIG. 12 is a schematic illustration of a color slippage detection mark printed by the image forming apparatus of FIG. 10 when a color slippage takes place.

FIG. 13 is a schematic illustration of a color slippage correction chart printed by the image forming apparatus of FIG. 10.

FIG. 14 is a schematic illustration of a system for manually correcting a color slippage by means of a color slippage correction chart as illustrated in FIG. 13.

FIG. 15 is a schematic illustration of a system for automatically correcting a color slippage by means of a color slippage correction chart as illustrated in FIG. 13.

### DETAILED DESCRIPTION

A description in greater detail is provided below by referring to the accompanying drawings that illustrate preferred embodiments of the application. However, it will be appreciated that the following embodiments can be modified and altered in various different ways without departing from the spirit and scope of the application.

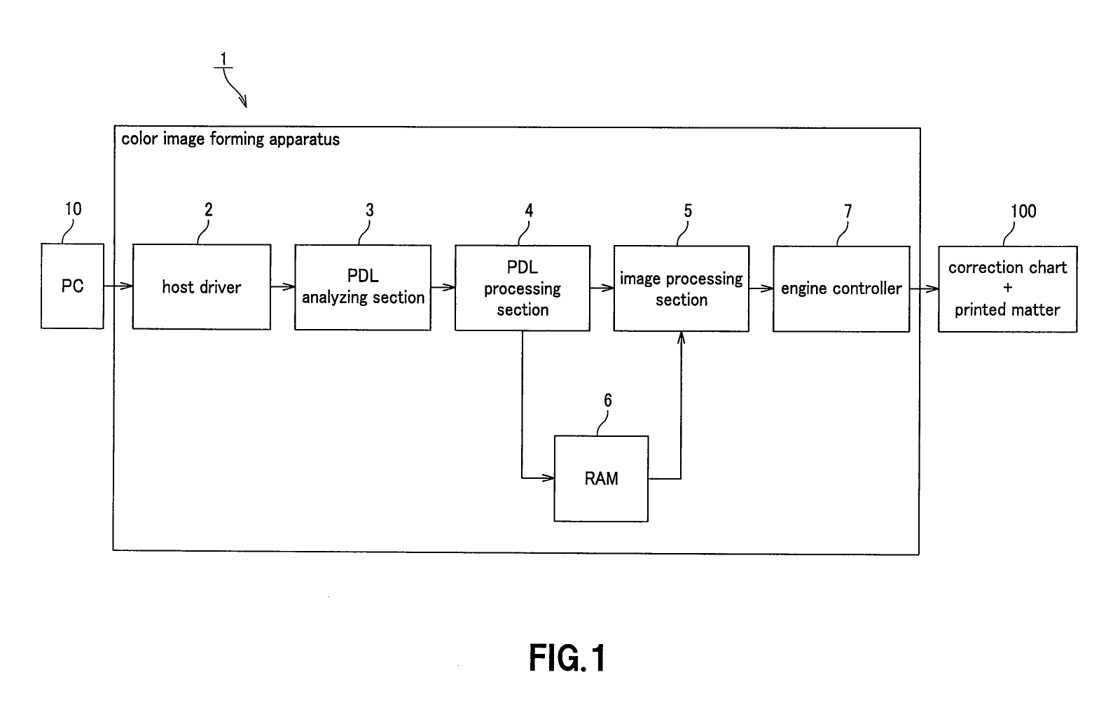

FIG. 1 is a schematic block diagram of an embodiment of color image forming apparatus 1 according to an embodiment.

Referring to FIG. 1, the color image forming apparatus 1 is a page printer to be connected to a host apparatus 10 such as a personal computer (PC) for use. The color image forming apparatus 1 includes a host driver 2 to be connected to the host apparatus 10, a page description language analyzing section 3 connected to the host driver 2, a PDL processing section 4 connected to the PDL analyzing section 3, an image processing section 5, a RAM (random access memory) 6, the image processing section 5 and the RAM 6 being connected to the PDL processing section 4, and an engine controller 7 connected to the image processing section 5.

The host apparatus 10 transmits printable data expressed in the page description language (PDL) and showing how the characters, the line drawings and the photographic image data on a page prepared by means of software such as DTP (desk top publishing) software are reproduced, to the color image forming apparatus 1.

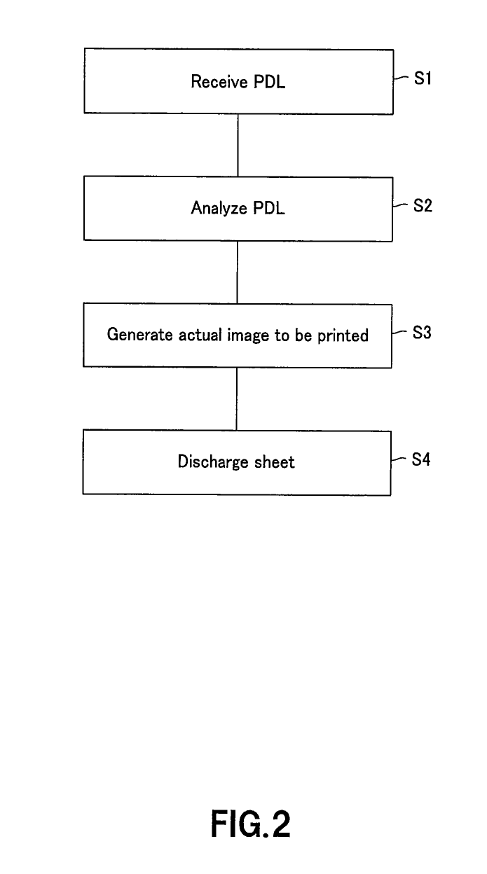

Referring now to the flowchart of FIG. 2, the color image forming apparatus 1 receives the printable data described in the PDL and transmitted from the host apparatus 10 by the host driver 2 (Step S1) and then analyzes the printable data it receives by means of the PDL analyzing section 3 (Step S2). Subsequently, it processes the printable data at the PDL processing section 4 to generate an actual image to be printed and unfolds the data in a bit map state on the RAM 6 (Step S3).

Then, the image processing section 5 delivers the data in a bit map state that are unfolded in the RAM 6 to the engine controller 7 to print the data on a sheet of paper and discharges the printed sheet of paper (Step S4).

The PDL is a language for controlling the page printer or describing the output of the printer. With the PDL, generally it is possible to specify an abstract and sophisticated printing instruction that is not dependent on the resolution of the actual page printer. The PDL is equipped with a functional feature of defining characters and formats and that of drawing graphics. Thus, the data written in this language are sent to the printer and the printer by turn generates and outputs an image according to the data. Upon receiving the instruction in the page described language, the page printer computationally determines the image to be printed on a page on the basis of the internal outline font and other factors and then actually prints the page.

With this embodiment, the printable data that the host apparatus 10 transmits to the color image forming apparatus 1 contains data for printing a color registration correction chart so that the color image forming apparatus 1 prints a registration mark for color printing that includes a mark of a reference color and a mark of a color for measurement that are centered at a same position and have similar figures on a sheet of paper and, if there is a relative positional displacement between the mark of the reference color and the mark of the color for measurement, the apparatus 1 judges it as misregistration or color slippage.

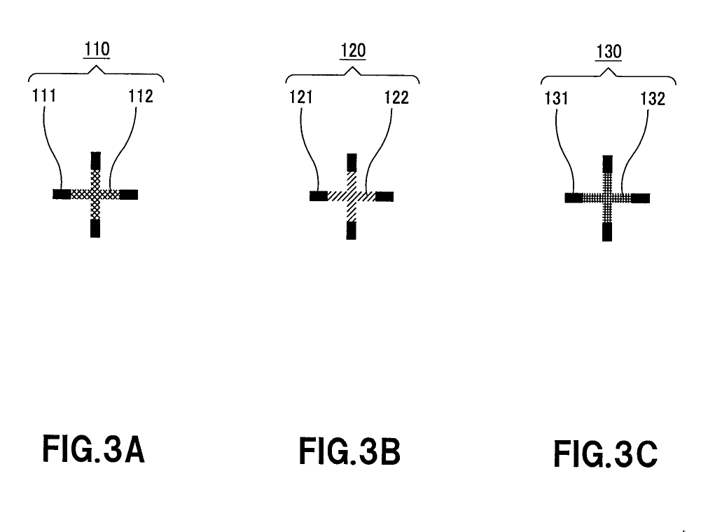

For example, the registration mark for color printing that the color image forming apparatus 1 prints may include a mark of a reference color and a mark of a color for measurement that are cross-shaped as shown in any of FIGS. 3A, 3B and 3C.

The first registration mark for color printing 110 illustrated in FIG. 3A is for judging the misregistration, or the color slippage, of the first color for measurement (cyan) relative to the reference color (black) and includes a cross-shaped mark of the reference color (black) 111 and a cross-shaped mark of the first color for measurement (cyan) 112.

The second registration mark for color printing 120 illustrated in FIG. 3B is for judging the misregistration, or the color slippage, of the second color for measurement (magenta) relative to the reference color (black) and includes a cross-shaped mark of the reference color (black) 121 and a cross-shaped mark of the second color for measurement (magenta) 122.

The third registration mark for color printing 130 illustrated in FIG. 3C is for judging the misregistration, or the color slippage, of the third color for measurement (yellow) relative to the reference color (black) and includes a cross-shaped mark of the reference color (black) 131 and a cross-shaped mark of the third color for measurement (yellow) 132.

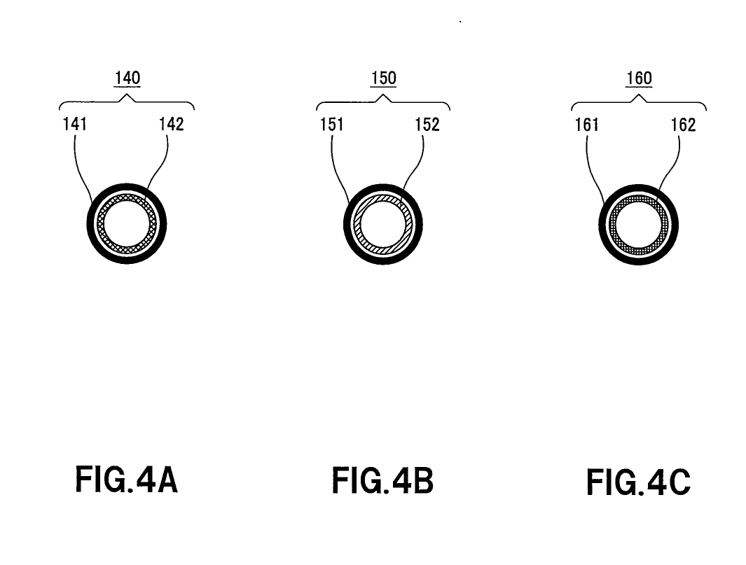

Alternatively, the registration mark for color printing that the color image forming apparatus 1 prints may include a mark of a reference color and a mark of a color for measurement that are concentric circles as shown in any of FIGS. 4A, 4B and 4C.

The fourth registration mark for color printing 140 illustrated in FIG. 4A is for judging the misregistration, or the color slippage, of the first color for measurement (cyan) relative to the reference color (black) and includes a circular mark of the reference color (black) 141 and a concentrically circular mark of the first color for measurement (cyan) 142.

The fifth registration mark for color printing 150 illustrated in FIG. 4B is for judging the misregistration, or the color slippage, of the second color for measurement (magenta) relative to the reference color (black) and includes a circular mark of the reference color (black) 151 and a concentrically circular mark of the second color for measurement (magenta) 152.

The sixth registration mark for color printing 160 illustrated in FIG. 4C is for judging the misregistration, or the color slippage, of the third color for measurement (yellow) relative to the reference color (black) and includes a circular mark of the reference color (black) 161 and a concentrically circular mark of the third color for measurement (yellow) 162.

When, for instance, the above-described cross-shaped registration marks for color printing 110, 120, 130 are printed and the color of cyan is displaced lower right, a space is produced at an upper position and at a left position between the cross-shaped mark of the reference color (black) 111 and the cross-shaped mark of first color for measurement (cyan) 112 of the first registration mark for color printing 110 as shown in FIG. 5. This is because, when a smaller cross-shaped mark of the first color for measurement (cyan) 112 is drawn on a larger cross-shaped mark of the reference color (black) 111, no black is printed on the cross-shaped part of the first color for measurement (cyan) in the cross of the reference color (black) by the nature of emulation.

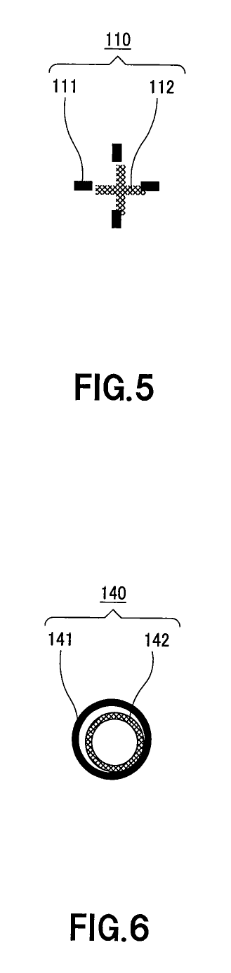

Similarly, when the above-described concentrically circular registration marks for color printing 140, 150, 160 are printed and the color of cyan is displaced lower right, the circular mark of the reference color (black) 141 and the circular mark of the first color for measurement (cyan) 142 of the fourth registration mark for color printing 140 overlap, or almost overlap, each other as shown in FIG. 6.

Any of the above-described registration marks for color printing is printed in such a way that the mark of the reference color (black) is printed first and then the mark of a color for measurement on the chart that is smaller than the mark of the reference color (black) is printed thereon. While the mark of a color for measurement is smaller than the mark of the reference color (black), it has a line width as large as the mark of the reference color (black).

Thus, as the mark of a color for measurement and the mark of the reference color are made similar in shape and centered at the same position, it is possible to visually detect any color slippage with ease.

Note that a registration mark for color printing is required only to include a mark of the reference color and a mark of a color for measurement that are centered at the same position and have similar figures. In other words, the mark of a color for measurement may be larger than the mark of the reference color (black).

Thus, as the mark of the reference color and the mark of a color for measurement are centered at the same position and made to have similar figures, it is possible to easily and clearly recognize a relative positional displacement of the mark of the reference color and the mark of a color for measurement that are printed on a sheet of paper as misregistration, or color slippage.

For the purpose of the present invention, the shape of a registration mark for color printing according to the present invention is not limited to crosses or concentric circles and may have any other forms.

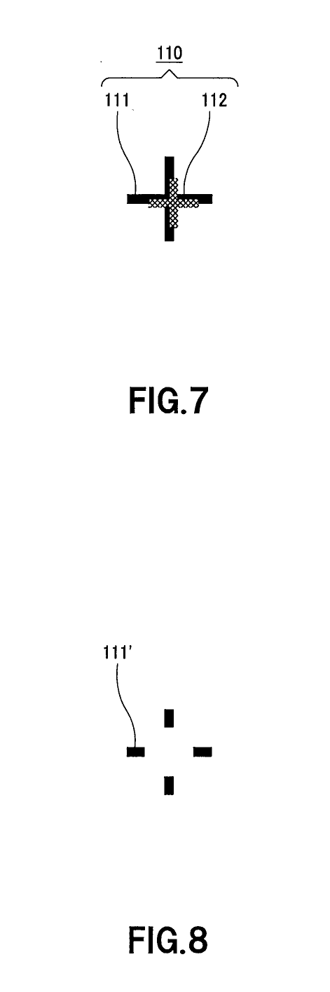

While spaces are produced between the cross-shaped mark of the reference color (black) 111 and the cross-shaped mark of a color for measurement (cyan) 112 when there is a color slippage in the color image forming apparatus 1 in the above description, steps are produced between the cross-shaped mark of the reference color 111 and the cross-shaped mark of a color for measurement 112 as shown in FIG. 7 if no space is produced so that it is possible to easily and clearly recognize a relative positional displacement of the mark of the reference color and the mark of a color for measurement that are printed on a sheet of paper as misregistration, or color slippage, by way of the steps.

Of the similar marks of a registration mark for color printing according to the present invention, the larger mark may be formed by cutting out the smaller mark from a cross as in the case of the mark of the reference color 111′ illustrated in FIG. 8. Then, spaces are produced between the cross-shaped mark of a color for measurement and the cross-shaped mark of the reference color without resorting to the nature of emulation. Thus, it is possible to easily and clearly recognize a relative positional displacement of the mark of the reference color and the mark of a color for measurement that are printed on a sheet of paper as misregistration, or color slippage, by way of steps and spaces.

It may be needless to say that a larger mark can be used as mark of a color for measurement while a smaller one can be used as mark of the reference color.

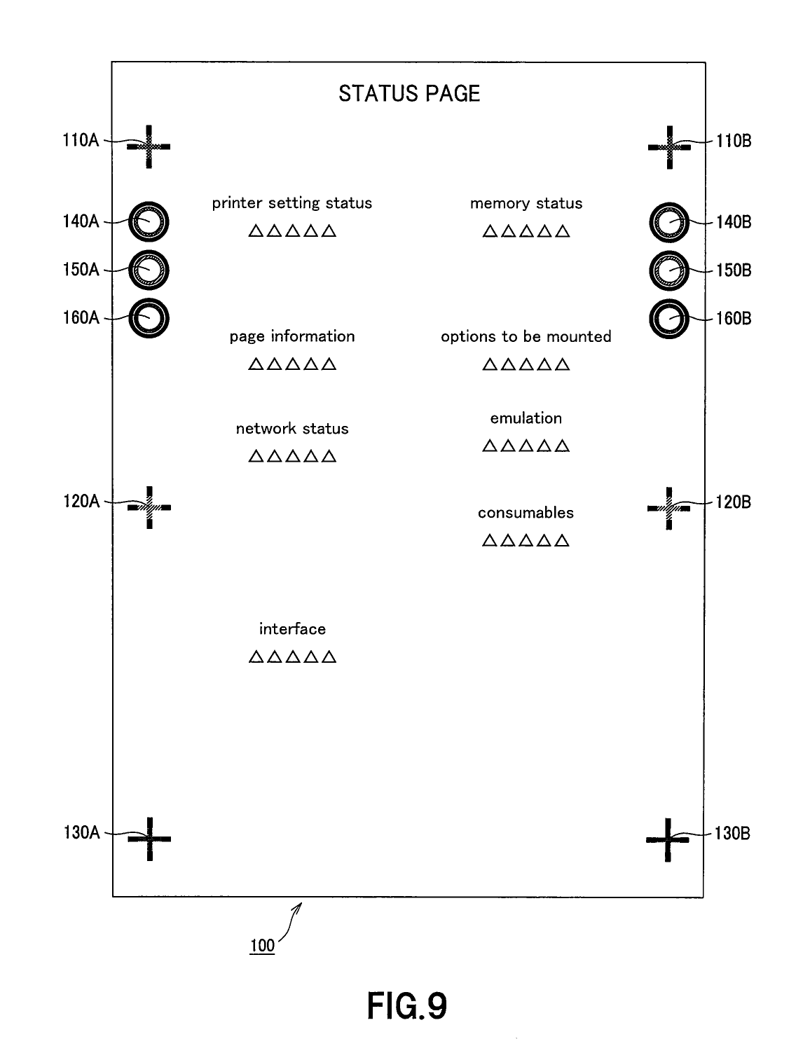

In the color image forming apparatus 1 of this embodiment, the data for printing a color registration correction chart are transmitted from the host apparatus 10 when printing a status page. Then, a color registration correction chart 100 is prepared typically by printing the first through six registration marks for color printing on a sheet of paper along with information on the setting of the printer, the page, the network status, the memory status, the options to be mounted and consumables as shown in FIG. 9.

The color registration correction chart 100 carries the first through sixth registration marks for color printing 110A through 160A, 110B through 160B printed on a sheet of paper and arranged transversally symmetrically as so many pairs.

Thus, with the color registration correction chart 100 where registration marks for color printing 110A through 160A, 110B through 160B are printed on a sheet of paper and arranged transversally symmetrically as so many pairs, it is possible to determine the existence or non-existence of misregistration, or color slippage, not only at respective positions of the registration marks for color printing 110A through 160A, 110B through 160B but also in any rotational directions by comparing the registration marks for color printing 110A through 160A and the registration marks for color printing 110B through 160B of the pairs for misregistration.

While the data of the contents of the color registration correction chart to be printed are transmitted to the above-described color image forming apparatus 1 from the host apparatus 10 and the color registration correction chart is prepared by printing the first through sixth registration marks for color printing 110A through 160A, 110B through 160B by using the transmitted data in the above description, it may alternatively be so arranged that the color image forming apparatus 1 additionally includes a storage section 8 for storing the data of the contents of the color registration correction chart to be printed and a control section 9 for controlling the operation of reading out the data for printing the registration marks for color printing from the storage section 8 and printing the registration marks for color printing according to an instruction. Then, the color image forming apparatus 1 is provided with a functional feature of preparing a color registration correction chart according to a command issued by the user for preparing it.

While the color image forming apparatus 1 of the above-described embodiment prints one or more than one registration marks, each including a mark of a reference color and a mark of a color for measurement that are centered at a same position and have similar figures, on a sheet of paper and judges the relative positional displacement of the mark of the reference color and the mark of a color for measurement printed on the sheet of paper as misregistration, or color slippage, the present invention is by no means limited thereto.

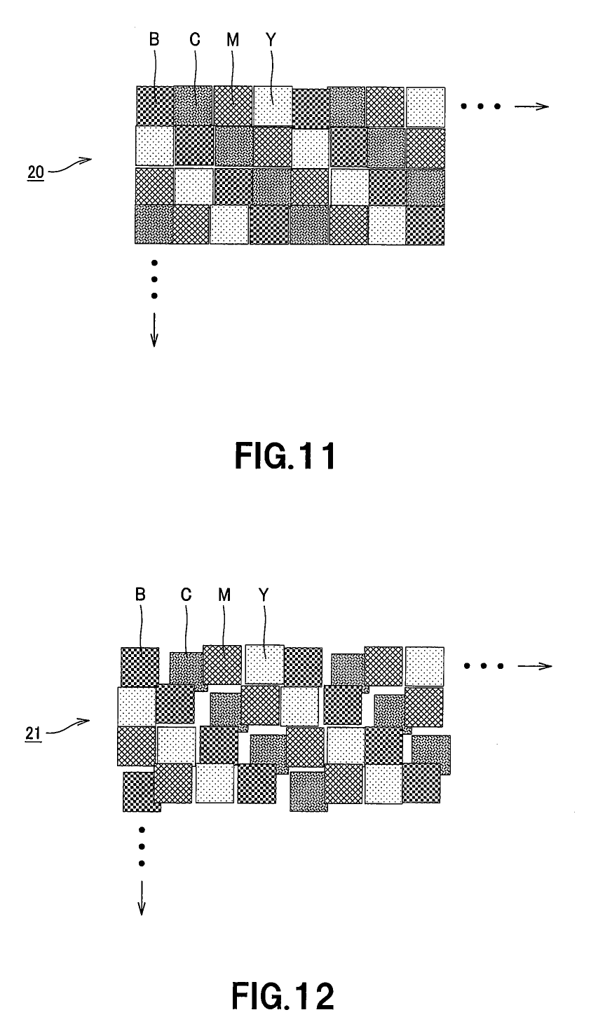

In the embodiment that will be described below, the printable data transmitted from the host apparatus 10 to the color image forming apparatus 1 contain printing data for printing a color slippage detection mark formed by dots of printing colors of black (B), cyan (C), magenta (M) and yellow (Y) alternately arranged as repetition of a unit of a predetermined number of dots as shown in FIG. 11. Thus, the color image forming apparatus 1 prints a color slippage detection mark formed by dots of printing colors alternately as repetition of a unit of a predetermined number of dots and detects a color slippage.

The color slippage detection mark 20 illustrated in FIG. 11 is printed without color slippage and the attributes of the colors of the color slippage detection mark 20 that is printed without color slippage are observed in advance by means of a calorimeter and the information obtained on the observed attributes of the colors is stored. Thus, thereafter, it is possible to judge if there is a color slippage or not by printing the color slippage detection mark on a sheet of paper and observing the attributes of the colors.

The attributes of the colors that are measured by a calorimeter include lightness, saturation, and hue. Any calorimetric system may be used for the calorimetric observation. In other words, a calorimetric system may be selected from the Munsell color system, the L*a*b* color system, the L*C*h color system, the Hunter Lab color system and the XYZ (Yxz) color system. Only a single element or a plurality of elements of the selected color system may be observed. For example, L* and C* may be measured when the L*C*h color system is selected.

When only a single element selected from lightness, saturation and hue is observed for the detection of color slippage, the observed calorimetric value may simply be compared with a reference value. When all the three elements are observed, the color difference may be determined as color slippage. When two of the three elements are observed, the arithmetic operation for determining the color difference may be applied and formula (1) shown below may be used.
[color difference]=((ΔL*)²+(ΔC*)²)^{1/2} (1)

When, for example, a phenomenon of color slippage as shown in FIG. 12 takes place, the lightness, the saturation and the hue observed as attribute information by means of the color slippage detection mark 21 printed on a sheet of paper are different from the lightness, the saturation and the hue that are observed as attribute information of the colors by means of the color slippage detection mark 20 printed on a sheet of paper without color slippage. It will be appreciated that cyan (C) shows a color slippage toward lower right in the instance illustrated in FIG. 12.

While the color slippage detection mark that is printed by the color image forming apparatus 1 is formed by dots of printing colors of black (B), cyan (C), magenta (M) and yellow (Y) alternately arranged as repetition of a unit of a predetermined number of dots, the sensitivity of the calorimeter to be used for the measurement will be low when the number of dots of the unit of repetition is large. In other words, the number of dots that can be used as unit of repetition for calorimetric observations is limited and preferably the unit of repetition of dots of printing colors is the smallest unit of dots.

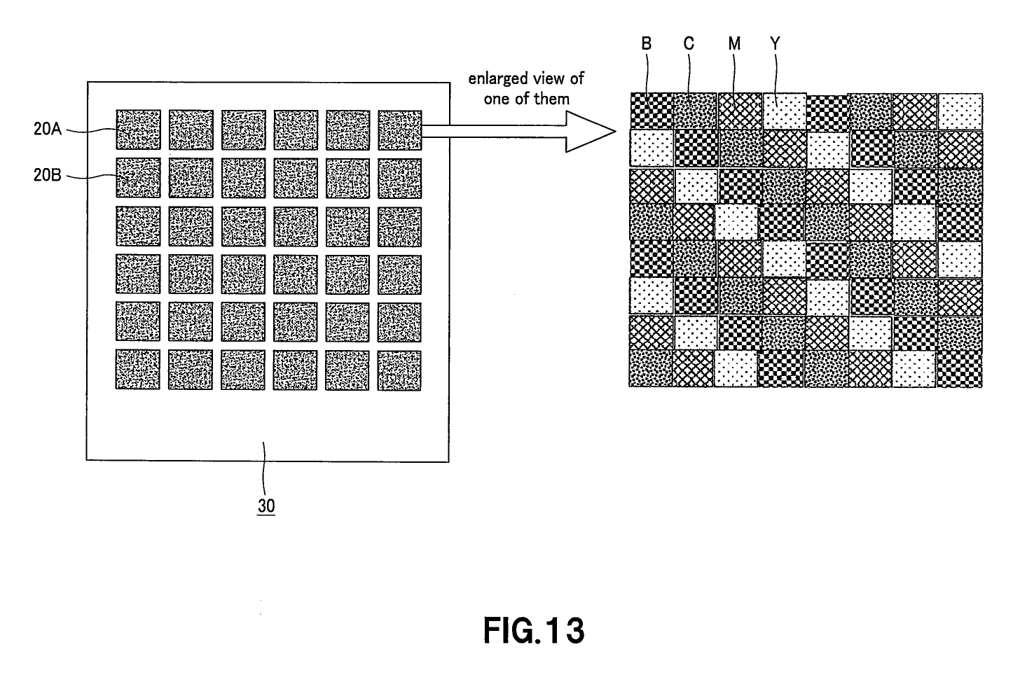

Alternatively, as shown in FIG. 13, a color slippage correction chart 30 including color slippage detection marks 20A, 20B, . . . of a plurality of different types may be printed on a sheet of paper and the color slippage mark that shows values closest to those that are free from color slippage in terms of lightness, saturation and hue may be selected from the color slippage correction chart 30 so that a correcting operation may be conducted according the selected color slippage mark.

In the color slippage detection marks 20A, 20B, . . . of a plurality of different types of the color slippage correction chart 30 of FIG. 13, cyan (C), magenta (M) and yellow (Y) are positively displaced in a direction or another by the smallest unit of correction.

Each of the colors of cyan (C), magenta (M) and yellow (Y) is displaced rightward or downward in each of the color slippage detection marks 20A, 20B, . . . . More specifically, the color slippage detection marks 20A, 20C, . . . are prepared according to information telling which color is displaced in which direction. Since the number of colors is three (the reference color, or black, is excepted) and if two directions are used for displacement, various patterns may be realized by entering a value selected from various positive and negative values to each box in Table 1 shown below.

TABLE 1
Combination of Color Slippage Patterns

| cyan | | magenta | | yellow | |
|---|---|---|---|---|---|
| Horizontal | Vertical | Horizontal | Vertical | Horizontal | Vertical |
| direction | direction | direction | direction | direction | direction |
| 0(±) | 0(±) | 0(±) | 0(±) | 0(±) | 0(±) |

Each value is the value for correction.

With the color slippage correction chart 30, it is possible to accurately detect any color slippage by selecting the color slippage mark that shows values closest to those that are free from color slippage in terms of lightness, saturation and hue out of the color slippage detection marks 20A, 20B, . . . .

There is not any necessity of correction when the color slippage detection mark for no color slippage shows the closest value.

If some other color slippage detection mark shows the closest values, it is possible to accurately correct the color slippage by correcting the color in the direction opposite to that of displacement of the displaced color in the color slippage correction mark. For example, if magenta (M) is shifted in a horizontal direction by +1 and yellow (Y) is shifted in a horizontal direction by +2 and in a vertical direction by −1 in the color slippage detection mark that shows values closest to those that are free from color slippage in terms of lightness, saturation and hue, the colors can be corrected by shifting magenta (M) leftward by −1 and yellow (Y) leftward by −2 and upward by +1.

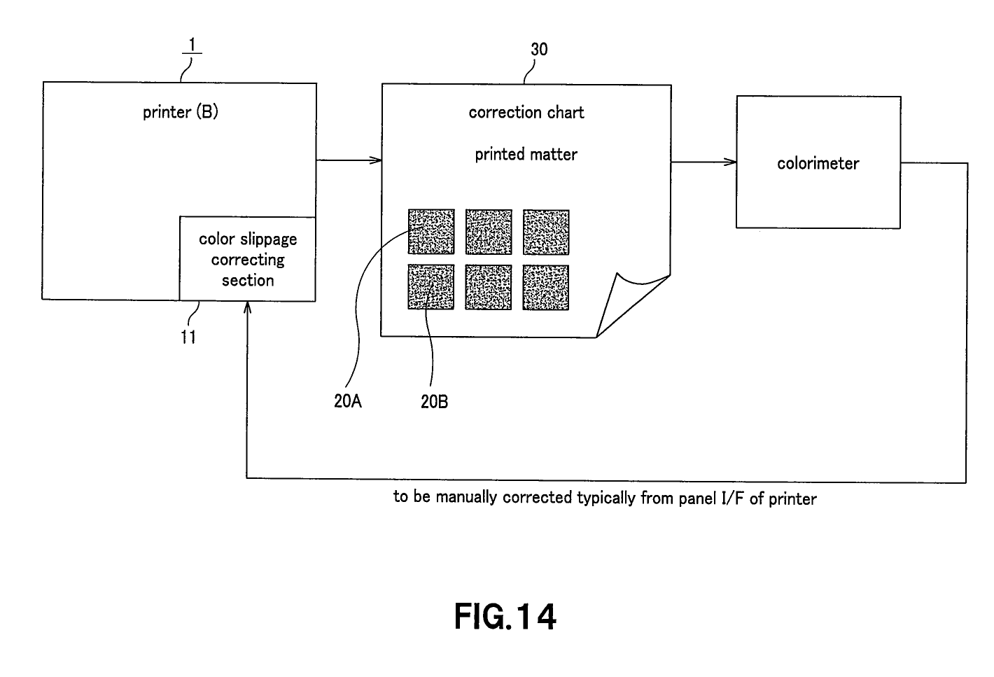

With the color image forming apparatus 1 having the functional feature of printing color slippage correction charts 30 including color slippage detection marks 20A, 20B, . . . of a plurality of different types as shown in FIG. 13, it is possible to observe the color slippage detection marks 20A, 20B, . . . of the different colors of the printed color slippage correction chart 30 by means of a calorimeter and correct the color slippage, if any, by manually operating color slippage correcting section 11, referring to the color showing a color slippage in the color slippage detection mark of the color closest to the color free from color slippage and the direction of color slippage as shown in FIG. 14.

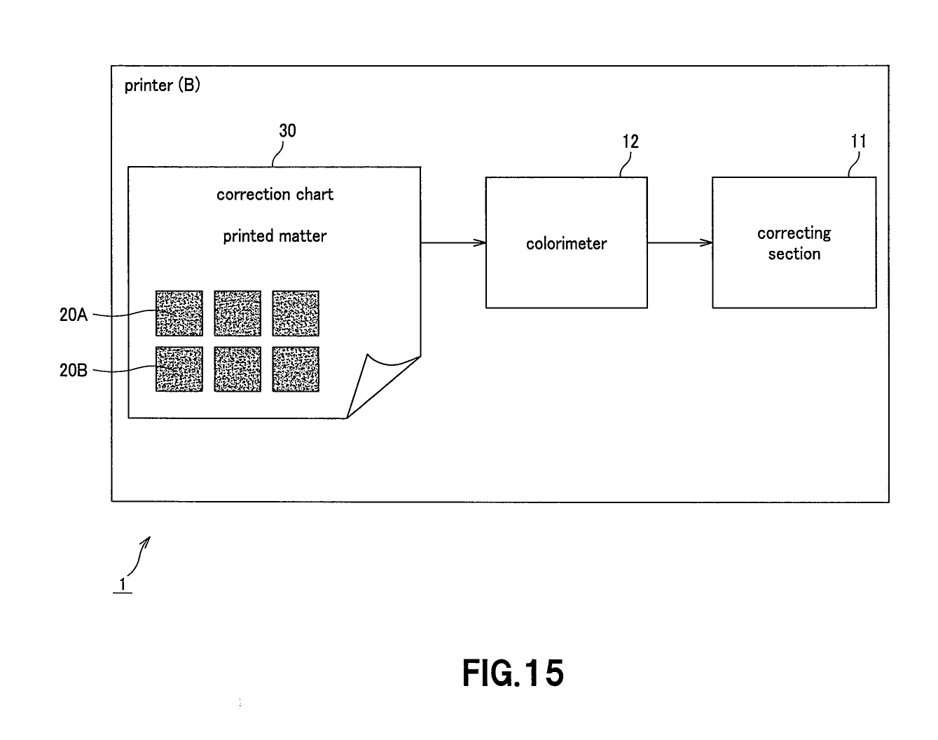

Alternatively, the color image forming apparatus 1 may be made to include a calorimeter section 12 to observe the color slippage detection marks 20A, 20B, . . . of the different colors of the printed color slippage correction chart 30. Then, it is possible to correct the color slippage, if any, by automatically operating color slippage correcting section 11, referring to the color showing a color slippage in the color slippage detection mark of the color closest to the color free from color slippage and the direction of color slippage as shown in FIG. 15.

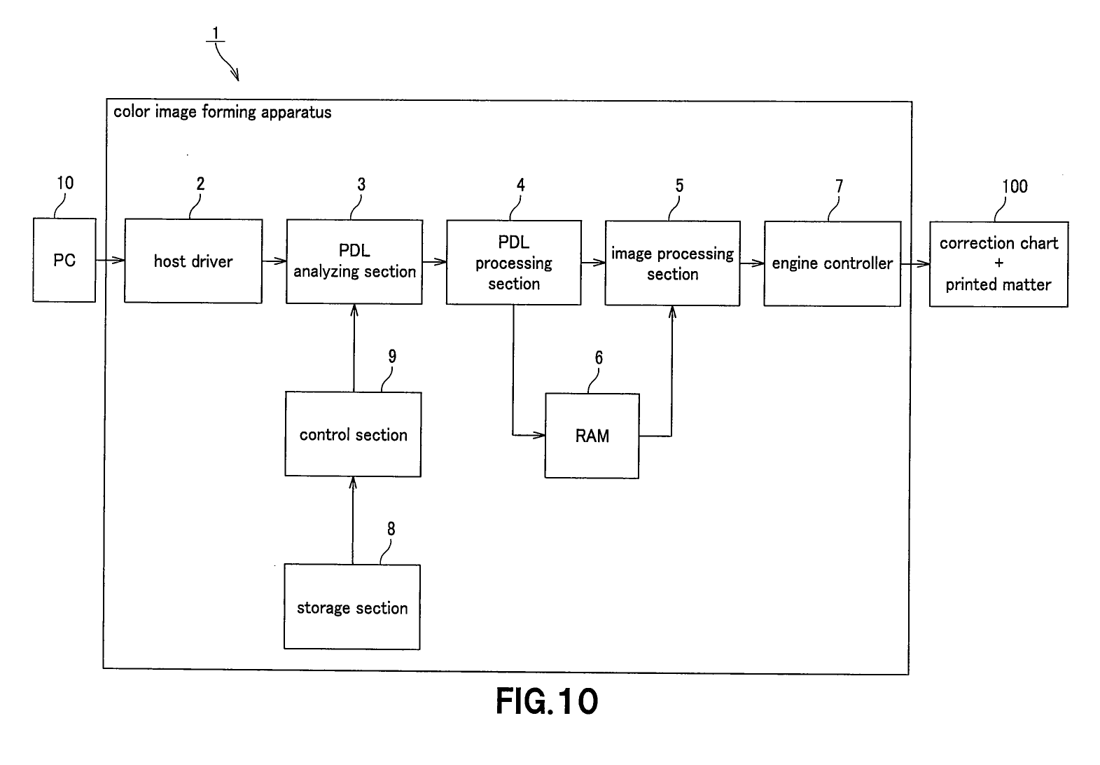

While the color image forming apparatus 1 is adapted to print color slippage detection marks 20 on a sheet of paper according to the data transmitted from the host apparatus 10 in the above description, the configuration illustrated in FIG. 10 and described above may alternatively be used. Then, the data for printing the color slippage detection marks 20 are stored in the storage section 8. The color image forming apparatus 1 includes a control section 9 for controlling the operation of reading out the data for printing the color slippage detection marks 20 from the storage section 8 and printing the color slippage detection marks 20 according to an instruction. Then, the color image forming apparatus 1 is provided with a functional feature of printing the color slippage detection marks 20 according to a command issued by the user for preparing it.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A misregistration judging method comprising the steps of:
printing a registration mark for color printing including a mark of a reference color and a mark of a color for measurement, the marks being centered at a same position and having similar figures, on a sheet of paper; and
judging a relative positional displacement, if any, of the mark of the reference color and the mark of the color for measurement printed on the sheet of paper as misregistration.

2. A registration mark for color printing comprising:
a mark of a reference color; and
a mark of a color for measurement which is centered at a same position as the mark of a reference color, and has a figure which is similar to that of the mark of a reference color.

3. The registration mark for color printing according to claim 2, wherein
the mark of the reference color and the mark of the color for measurement are concentric circles.

4. The registration mark for color printing according to claim 2, wherein
the mark of the reference color and the mark of the color for measurement are crosses.

5. The registration mark for color printing according to claim 2, wherein
the larger one of the mark of the reference color and the mark of the color for measurement has a figure formed by cutting out the figure of a smaller one.

6. A color registration correction chart comprising:
a registration mark for color printing which is printed on a sheet of paper, the registration mark for color printing including
a mark of a reference color, and
a mark of a color for measurement which is centered at a same position as the mark of a reference color, and has a figure which is similar to that of the mark of a reference color.

7. The color registration correction chart according to claim 6, wherein
registration marks for color printing are printed at symmetrical positions to form one or more than one pairs on a sheet of paper.

8. The color registration correction chart according to claim 6, wherein
the mark of the reference color and the mark of the color for measurement are concentric circles.

9. The color registration correction chart according to claim 6, wherein
the mark of the reference color and the mark of the color for measurement are crosses.

10. The color registration correction chart according to claim 6, wherein
a larger one of the mark of the reference color and the mark of the color for measurement has a figure formed by cutting out the figure of a smaller one.

11. A color image forming apparatus comprising:
storage means for storing printing data of a registration mark for color printing, the registration mark for color printing including
a mark of a reference color, and
a mark of a color for measurement which is centered at a same position as the mark of a reference color, and has a figure which is similar to that of the mark of a reference color; and
control means for controlling the operation of reading the printing data of the registration mark for color printing from the storage means and printing it on a sheet of paper according to an instruction.

12. The apparatus according to claim 11, wherein
the storage means stores printing data for printing registration marks for color printing at symmetrical positions to form one or more than one pairs on a sheet of paper.

13. The apparatus according to claim 11, wherein
the mark of the reference color and the mark of the color for measurement are concentric circles.

14. The apparatus according to claim 11, wherein
the mark of the reference color and the mark of the color for measurement are crosses.

15. The apparatus according to claim 11, wherein
a larger one of the mark of the reference color and the mark of the color for measurement has a figure formed by cutting out the figure of a smaller one.

16. A color slippage detection mark comprising:
dots of printing colors alternately arranged as repetition of a unit of a predetermined number of dots.

17. The color slippage detection mark according to claim 16, wherein
the unit of repetition of dots of printing colors is the smallest unit of dots.

18. A color slippage detection method comprising the steps of:
preliminarily measuring color attributes of a color slippage detection mark including dots of printing colors alternately arranged as repetition of a unit of a predetermined number of dots;
storing the measured color attributes; and
detecting a color slippage, if any, by printing the color slippage detection mark on a sheet of paper, measuring color attributes and comparing them with the stored color attributes.

19. A color image forming apparatus comprising:
storage means for storing a color slippage detection mark including dots of printing colors alternately arranged as repetition of a unit of a predetermined number of dots; and
control means for controlling the operation of reading the printing data of the color slippage detection mark from the storage means and printing it on a sheet of paper according to an instruction.

20. A color slippage correction chart comprising:
color slippage detection marks of several different types formed by means of dots of printing colors alternately arranged as repetition of a unit of a predetermined number of dots and shifting the printing colors in a direction by the smallest unit of correction.

21. A color slippage correction method comprising the steps of:
printing color slippage correction charts of printing colors on a sheet of paper, each including color slippage detection marks of several different types formed by means of dots of printing colors alternately arranged as repetition of a unit of a predetermined number of dots and shifting the printing colors in a direction by the smallest unit of correction; and
measuring color attributes for the color slippage detection mark of each printing color of the color slippage correction chart printed on the sheet of paper, selecting a color slippage detection mark having color attributes close to those of the related target color and correcting the color slippage of the printing color according to the color slippage detection mark.

22. A color image forming apparatus comprising:
storage means for storing printing data on color slippage correction charts of printing colors, each including color slippage detection marks of several different types formed by means of dots of printing colors alternately arranged as repetition of a unit of a predetermined number of dots and shifting the printing colors in a direction by the smallest unit of correction; and
control means for controlling the operation of reading out the printing data on the color slippage correction chart from the storage means and printing them on a sheet of paper according to an instruction.
